(19) United States
(12) Patent Application Publication
(10) Pub. No.: US 2013/0117290 A1
(43) Pub. Date: May 9, 2013

(54) PLATFORM FOR SOFTWARE AS A SERVICE AND METHOD FOR PROVISIONING SERVICE FOR SUPPORTING MULTI-TENANTS USING THE PLATFORM

(71) Applicants: Kyoung Hyun Park, Daejeon (KR); Hee Sun Won, Daejeon (KR); Sung Jin Hur, Daejeon (KR)

(72) Inventors: Kyoung Hyun Park, Daejeon (KR); Hee Sun Won, Daejeon (KR); Sung Jin Hur, Daejeon (KR)

(73) Assignee: ELECTRONICS AND TELECOMMUNICATIONS RESEARCH INSTITUTE, Daejeon (KR)

(21) Appl. No.: 13/529,370

(22) Filed: Jun. 21, 2012

(30) Foreign Application Priority Data
Nov. 7, 2011 (KR) 10-2011-0115423

(51) Int. Cl. G06F 17/30

(52) U.S. Cl. 707/756; 707/736; 707/E17.005

(57) ABSTRACT

An SaaS platform for providing an SaaS (Software as a Service) service in cloud computing and a method for provisioning a service for supporting multi-tenants using the platform are provided. The SaaS platform includes a setting environment module configured to set an environment so that setting information for each tenant is converted into metadata to be stored, a metadata manager configured to manage the metadata for each tenant and application data, and an execution engine module configured, if a service request is received from a tenant user, to request the metadata of the corresponding tenant from the metadata manager, to load the metadata of the corresponding tenant transferred from the metadata manager, and to dynamically generate and provide a service to the tenant user.

### CROSS-REFERENCE TO RELATED APPLICATIONS

The present application claims priority to Korean patent application number 10-2011-0115423, filed on Nov. 7, 2011, which is incorporated by reference in its entirety.

### BACKGROUND OF THE INVENTION

The present invention relates to an SaaS (Software as a Service) platform and a method for provisioning a service for supporting multi-tenants using the platform, and more particularly, to an SaaS platform for providing an SaaS (Software as a Service) service in cloud computing and a method for provisioning a service for supporting multi-tenants using the platform.

SaaS is one of the service types that cloud computing provides, and lays stress on providing of software from a viewpoint of services.

In order for a user to receive software as a service, it is required to eliminate a software installation process and to enable a user to connect and use the software, if needed, with payment of costs only for the utilization period.

Accordingly, the SaaS service can be provided only on the basis of the clouding computing, and to meet such a flow, development of the SaaS platform and applications based on the clouding computing has been of great interest in domestic and international software markets.

The characteristics of the SaaS application as described above may be summarized into configurability of a setting function and support of multi-tenancy, and the SaaS platform provides the setting function and the multi-tenant support function, which are the characteristics of the SaaS application, as the core functions.

In order for the SaaS platform to provide a service to tenants, it is required to perform provisioning for each tenant.

The provisioning means setting of an environment so that the tenants can use the service, and the SaaS application based on setting information for each tenant performs provisioning that is different from that of the existing web application.

The background technology of the present invention is disclosed in the Korean Patent Publication No. 10-2011-0070689 (published on Jun. 24, 2011, Title of invention: Data schema generation device supporting multi-tenants and method thereof).

### SUMMARY OF THE INVENTION

Embodiments of the present invention are directed to an SaaS platform based on metadata that is required to provide a service to a plurality of tenants and a method for provisioning a service for supporting multi-tenants using the platform.

In one embodiment, an SaaS platform includes: a setting environment module configured to set an environment so that setting information for each tenant is converted into metadata to be stored; a metadata manager configured to manage the metadata for each tenant and application data; and an execution engine module configured, if a service request is received from a tenant user, to request the metadata of the corresponding tenant from the metadata manager, to load the metadata of the corresponding tenant transferred from the metadata manager, and to dynamically generate and provide a service to the tenant user.

The SaaS platform according to one embodiment may further include a metadata DB configured to store the setting information for each tenant set by the setting environment module; and an application DB configured to store the application data to be provided to the tenant user.

The setting environment module may set a user interface, a data schema, and a business logic part.

The execution engine module may dynamically generate the service to be provided to the tenant user through reflection of a code base and tenant setting information.

In another embodiment, a method for provisioning a service for supporting multi-tenants using an SaaS platform includes: if a tenant user requests a service, an execution engine module requesting metadata corresponding to a tenant from a metadata manager; the metadata manager searching for the metadata from a metadata DB and transferring the metadata to the execution engine module; the execution engine module generating the service using a code base and the metadata; and the generated service searching for data requested by the user from an application DB and providing the requested service to the tenant user.

In still another embodiment, a method for provisioning a service for supporting multi-tenants using an SaaS platform includes: storing table information for providing a service and registering the service; if the service registration is completed, performing tenant registration; and if the tenant registration is completed, setting a relationship between tables and completing a request for the service.

The table may include a basic information table configured to manage tenant and service information; a mapping information table configured to manage the relationship between the tables; and a setting information table configured to manage information set by the tenant.

The basic information table may include a company table configured to manage the tenant information; a user table configured to manage user information of the tenant; a service table configured to manage application information served to a tenant user; a menu table configured to manage menu information of an application; and a role table configured to manage role information for controlling an access right in the service.

The mapping information table may include a company-service table configured to manage the service information used by the company; a user-role table configured to manage the role information possessed by the tenant user; and a role-menu table configured to manage the menu information that the corresponding role can access.

The setting information table may include a page table configured to manage setting information of a web page; a schema table configured to manage setting information of an application schema; and a business logic table configured to manage business logic setting information for each tenant.

As described above, according to the present invention, a service provisioning is performed using an SaaS platform based on metadata that is required to provide a service to a plurality of tenants, and thus the providing of independent services for each tenant can be guaranteed.

### BRIEF DESCRIPTION OF THE DRAWINGS

FIG. 1 illustrates the structure of an SaaS platform according to an embodiment of the present invention.

FIG. 2 illustrates a conceptual diagram for using an SaaS service based on metadata according to an embodiment of the present invention.

FIG. 3 illustrates a procedure in which a tenant user receives a service according to an embodiment of the present invention.

FIG. 4 illustrates table information for supporting multi-tenants according to an embodiment of the present invention.

FIG. 5 illustrates a relationship between tables according to an embodiment of the present invention.

FIG. 6 illustrates a service provisioning procedure according to an embodiment of the present invention.

### DESCRIPTION OF SPECIFIC EMBODIMENTS

Hereinafter, embodiments of the present invention will be described in detail. These embodiments are merely exemplary, and thus the scope of the present invention is not limited to these embodiments.

In the drawings, line thicknesses or sizes of elements may be exaggerated for clarity and convenience. Also, the following terms are defined considering function of the present invention, and may be differently defined according to intention of an operator or custom. Therefore, the terms should be defined based on overall contents of the specification.

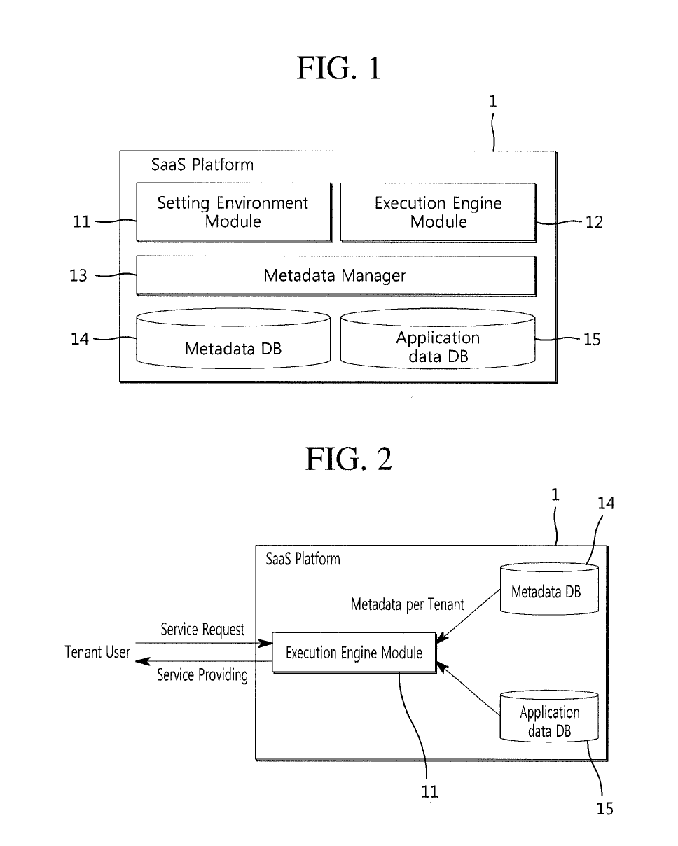

FIG. 1 illustrates the structure of an SaaS platform according to an embodiment of the present invention.

As illustrated in FIG. 1, in order to support a setting function and multi-tenants, an SaaS platform 1 has an architecture based on metadata, and includes a setting environment module 11, an execution engine module 12, a metadata manager 13, a metadata DB 14, and an application DB 15.

The setting environment module 11 is a module that is configured to convert information set for each tenant by a tenant manager into metadata and to store the metadata.

Parts that can be set by the tenant manager include a user interface (web page), a data schema, and a business logic part.

The execution engine module 12 is a module that is configured to load the metadata of the corresponding tenant and to dynamically generate and provide a service based on a code base to a user if the tenant user requests the service.

Accordingly, in order for the execution engine module 12 to support independent services, that is, multi-tenants, for multiple tenants, setting information composed of the code base and the metadata is required.

Here, the code base means one service inductance that corresponds to a service commonly provided to all tenants.

The metadata manager 13 is a module that manages the metadata for each tenant, and through the metadata manager, the SaaS platform 1 can support multi-tenants.

The database is divided into two databases. The metadata DB 14 for managing the metadata is a database that is present in the platform to manage the setting information for each tenant.

The application data DB 15 is a database for managing application data provided to the user, and may be present inside or outside the platform.

FIG. 2 illustrates a conceptual diagram for using an SaaS service based on metadata according to an embodiment of the present invention.

As illustrated in FIG. 2, the tenant user requests the service from a server to receive the service. When receiving the request from the tenant user, the SaaS platform 1 in the server request the metadata of the corresponding tenant from the metadata manager 13 on the basis of tenant information and tenant user information.

The metadata manager 13 searches for and transfers the setting information requested by the execution engine module 12. The execution engine module 12 dynamically generates the service provided to the tenant user through reflection of the code base and the tenant setting information. The dynamically generated service requests and brings the necessary data from the application DB 15, and then provides the data to the user.

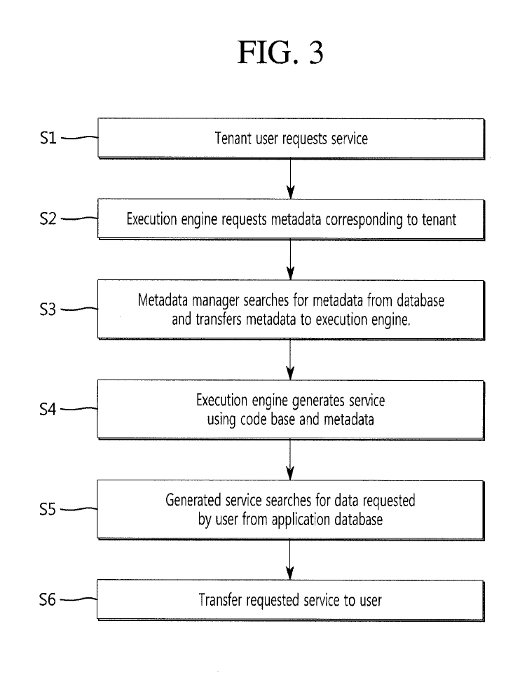

FIG. 3 illustrates a procedure in which a tenant user receives a service according to an embodiment of the present invention.

Referring to FIG. 3, in order for the tenant user to receive such a service, it is required to perform service provisioning for each tenant.

The service provisioning means a series of tasks to install and arrange resources that are required for the service in the system in order to provide the service to the tenant that has requested the service. Accordingly, the service provisioning in the SaaS application is focused on management of the setting information of the respective tenants and management of the service access right.

The main task of the provisioning is to generate data required for the service for each tenant and to store the data in the corresponding table, and the most important part of schemas required for the provisioning is a part related to the tenant right management. Here, the right management includes a user management, a role management, and a menu management.

Hereinafter, a process in which the tenant user receives the service will be described.

First, if the tenant user requests the service (S1), the execution engine module 12 of the SaaS platform 1 requests the metadata corresponding to the tenant from the metadata manager 13 (S2).

Then, the metadata manager 13 searches for the metadata from the metadata DB 14 and transfers the searched metadata to the execution engine module 12 (S3).

The execution engine module 12 generates the service using the code base and the metadata (S4).

The generated service searches for the data requested by the user from the application DB 15 (S5) and transfers the requested service to the tenant user (S6).

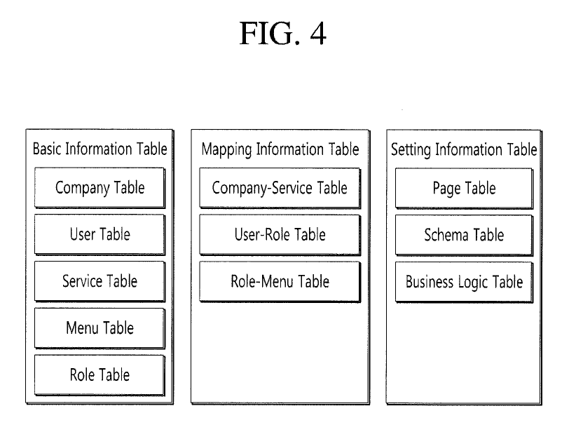

FIG. 4 illustrates table information for supporting multi-tenants according to an embodiment of the present invention.

In FIG. 4, a basic information table includes tables for managing the tenant and service information.

A company table of the basic information table manages the tenant information, a user table manages the user information of the tenant, and a service table manages the application information served to the tenant user. A menu table manages the menu information of an application, and the role table manages the role information for controlling the access right in the service.

A mapping information table includes tables for managing the relationship between the tables.

A company-service table of the mapping information table manages the service information used by the company, a user-role table manages the role information possessed by the tenant user, and a role-menu table manages the menu information that the corresponding role can access.

The setting information table includes tables for managing the information set by the tenant.

A page table of the setting information table manages the setting information of a web page, a schema table manages the setting information of an application schema, and a business logic table manages the business logic setting information for each tenant.

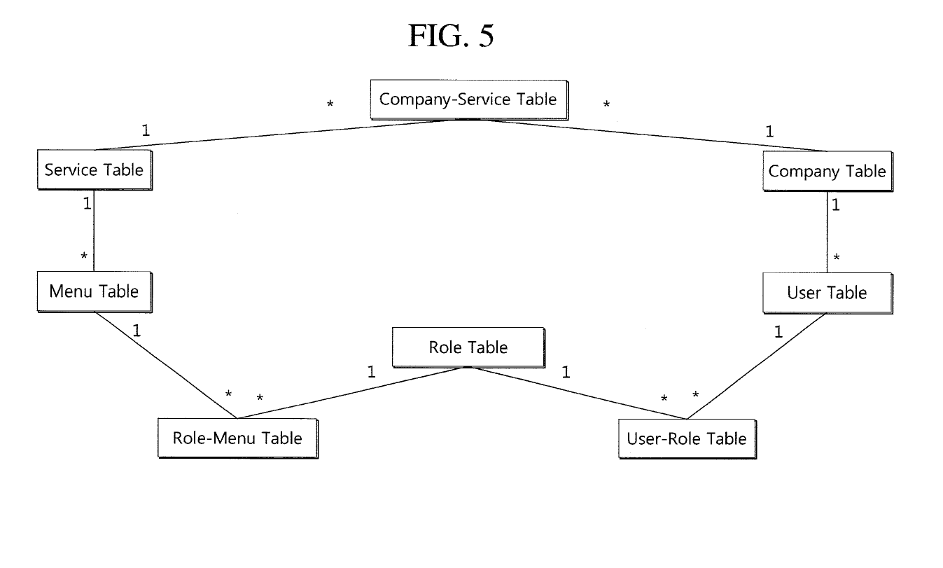

FIG. 5 illustrates a relationship between tables according to an embodiment of the present invention.

In FIG. 5, the relationship between the company table and the service table is managed by the company-service table, and the relationship between the user table and the role table is managed by the user-role table. Further, the relationship between the role table and the menu table is managed by the role-menu table.

In other words, FIG. 5 shows the relationships between the right management schemas. The tenant includes tenant users, and the application includes access menus. The user can receive the service through the access menu, and at this time, the users' services are controlled through the role of the user.

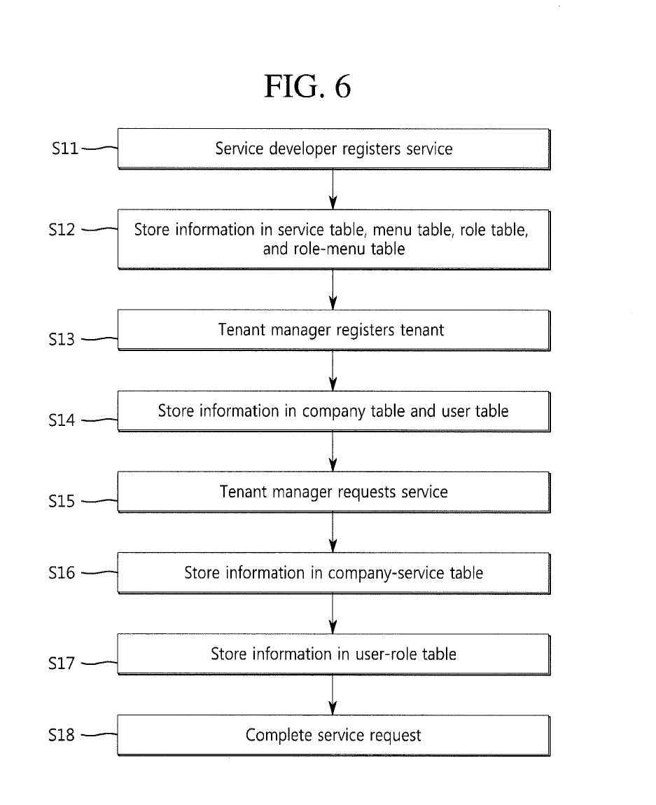

FIG. 6 illustrates a service provisioning procedure according to an embodiment of the present invention.

A service developer develops the service through a development tool, and registers the developed service in the server (S11).

When the service is registered in the server, corresponding information is stored in the service table, the menu table, the role table, and the role-menu table (S12).

The service table is to store information of the developed service. The menu table stores the menu information that the service includes. The role table stores the role information accessible to the service. Menu information that the respective roles can access are stored in the role-menu table.

If the storing of the information of the basic tables for providing the service is finished, the tenant manager performs tenant registration (S13).

During the tenant registration, the tenant information is stored in the tenant table, and the information of the tenant manager is stored in the user table (S14).

After completion of the tenant registration, the tenant manager requests the service (S15).

If the tenant requests the service to be provided, the information is stored in the company-service table (S16).

For the service manager right, the tenant manager sets the role of the tenant manager, and this information is stored in the user-role table (S17).

If the provisioning process is completed as described above, the tenant users can receive the service, and the SaaS platform can provide the service that supports multi-tenants to the tenants (S18).

In the case of providing the service to the tenants, the actual information set for each tenant is stored in the page table, the schema table, and the business logic table according to the contents of setting.

As described above, according to the present invention, through performing of the service provisioning using the SaaS platform based on the metadata that is required to provide the service to the plurality of tenants, the providing of independent services for each tenant can be guaranteed.

While the present invention has been described with respect to the specific embodiments, they are merely exemplary, and it will be apparent to those skilled in the art that various changes and modifications may be made without departing from the spirit and scope of the invention as defined in the following claims.

What is claimed is:

1. An SaaS platform comprising:
a setting environment module configured to set an environment so that setting information for each tenant is converted into metadata to be stored;
a metadata manager configured to manage the metadata for each tenant and application data; and
an execution engine module configured, if a service request is received from a tenant user, to request the metadata of the corresponding tenant from the metadata manager, to load the metadata of the corresponding tenant transferred from the metadata manager, and to dynamically generate and provide a service to the tenant user.

2. The SaaS platform of claim 1, further comprising:
a metadata DB configured to store the setting information for each tenant set by the setting environment module; and
an application DB configured to store the application data to be provided to the tenant user.

3. The SaaS platform of claim 1, wherein the setting environment module sets a user interface, a data schema, and a business logic part.

4. The SaaS platform of claim 1, wherein the execution engine module dynamically generates the service to be provided to the tenant user through reflection of a code base and tenant setting information.

5. A method for provisioning a service for supporting multi-tenants using an SaaS platform comprising:
if a tenant user requests a service, an execution engine module requesting metadata corresponding to a tenant from a metadata manager;
the metadata manager searching for the metadata from a metadata DB and transferring the metadata to the execution engine module;
the execution engine module generating the service using a code base and the metadata; and
the generated service searching for data requested by the user from an application DB and providing the requested service to the tenant user.

6. A method for provisioning a service for supporting multi-tenants using an SaaS platform comprising:
storing table information for providing a service and registering the service;
if the service registration is completed, performing tenant registration; and
if the tenant registration is completed, setting a relationship between tables and completing a request for the service.

7. The method of claim 6, wherein the table comprises:
a basic information table configured to manage tenant and service information;
a mapping information table configured to manage the relationship between the tables; and
a setting information table configured to manage information set by the tenant.

8. The method of claim 7, wherein the basic information table comprises:
a company table configured to manage the tenant information;
a user table configured to manage user information of the tenant;
a service table configured to manage application information served to a tenant user;
a menu table configured to manage menu information of an application; and
a role table configured to manage role information for controlling an access right in the service.

9. The method of claim 8, wherein the mapping information table comprises:
a company-service table configured to manage the service information used by the company;
a user-role table configured to manage the role information possessed by the tenant user; and
a role-menu table configured to manage the menu information that the corresponding role can access.

10. The method of claim 9, wherein the setting information table comprises:
a page table configured to manage setting information of a web page;
a schema table configured to manage setting information of an application schema; and
a business logic table configured to manage business logic setting information for each tenant.
